(19) United States
(12) Patent Application Publication
(10) Pub. No.: US 2025/0369765 A1
(43) Pub. Date: Dec. 4, 2025

(54) METHOD OF SELECTING DESTINATIONS BASED ON HABITS AND PASSENGERS

(71) Applicant: Volvo Car Corporation, Göteborg (SE)

(72) Inventors: Johannes Overesch, Göteborg (SE); Denis Bourgoin, Göteborg (SE); Jonas Carlsson, Göteborg (SE)

(21) Appl. No.: 18/679,616

(22) Filed: May 31, 2024

(51) Int. Cl. G01C 21/34; G06Q 50/40

(52) U.S. Cl. CPC G01C 21/3484; G06Q 10/02; G06Q 50/47

(57) ABSTRACT

A system for providing vehicle navigation routing based on passenger habits includes a passenger information module and a navigation routing module. The passenger information module retrieves one or more of past travel information or future schedule information for one or more passengers of the vehicle. The navigation routing module receives a navigation request from the passenger(s) of the vehicle and determines a final destination and an intermediate destination based on the navigation request and the past travel information and/or the future schedule information for the passenger(s). The navigation routing module also generates a guidance route including the intermediate destination and the final destination.

### TECHNICAL FIELD

The present disclosure relates generally to the automotive field. More particularly, the present disclosure relates to providing vehicle navigation routing based on habits of the passengers of the vehicle.

### BACKGROUND

Vehicle navigation and routing such as GPS navigation has proven useful for travel assistance, especially compared to using a physical map. Current vehicle navigation allows for an operator to select one or more destinations and may provide an estimated arrival time at the destination(s). However, the operator and/or other occupants of the vehicle, i.e., one or more passengers, must personally ensure that they arrive at their final destination by a required time, e.g., arrive at work by a start time or arrive at a party on time. The passengers must guess how long they will be at any intermediate destination(s), such a breakfast stop. Guessed destination durations can be wildly inaccurate, causing the passengers to be late to the final destination. It may also be challenging to find an intermediate destination, such as a breakfast location, a coffee location, or convenience store that is best for all of the passengers. Often, the driver/operator of the vehicle chooses his or her favorite option and begins the journey. Even if the driver/operator asks the other passenger(s) for destination options, it may be difficult to determine the best option. Some passengers may be very vocal about a minor preference, while other passengers can be more timid and remain silent even though they have strong preferences or dietary restrictions that should eliminate certain options.

As such, a need exists in the art for a system and associated methods, control systems for vehicles that overcome the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide systems for navigation routing based on passenger habits and associated methods of operation and control systems that overcome the limitations of the known art. Thus present disclosure is directed to a system for providing vehicle navigation routing based on passenger habits and associated computer-implemented method.

Embodiments of the disclosed systems and methods facilitate choosing destinations based on a navigation request from one or more passengers of a vehicle and the qualities, past travel information, and/or schedule requirements of the passenger(s). A passenger information module and associated method elements may retrieve passenger information, such as passenger qualities, past travel information for the passenger(s), and/or future schedule information for the passenger(s). For example, such passenger information may be retrieved from one or more personal devices, mobile devices, cell phones, or the like of the passenger(s). In another example, the passenger(s) may be identified and associated with one or more passenger profiles, and some or all of the passenger information may be retrieved from the associated passenger profile(s). In some such embodiments, the passenger information module and associated method elements can identify the passenger(s) of the vehicle, the number of passengers, and/or assign passenger identifications (passenger IDs) based on passenger data indicating the passenger(s), such as vehicle sensor data and/or data retrieved from the personal device(s) of the passenger(s). Such determinations may be made utilizing appropriate artificial intelligence algorithms and/or by comparing qualities or features of the passenger(s) indicated by the passenger data and/or passenger profile(s).

A navigation routing module and associated method elements can receive the navigation request (e.g., a natural language statement, spoken command, or the like) from the passenger(s) of the vehicle and determine a final destination and one or more intermediate destinations based on the navigation request and the passenger information (e.g., the passenger qualities, the past travel information for the passenger(s), and/or the future schedule information for the passenger(s)). For example one or more suitable artificial intelligence algorithms or natural language processing algorithms may identify the final destination, the intermediate destination(s), types of such destinations (e.g., coffee places, breakfast restaurants, convenience stores, pharmacies, etc.), and/or one or more required arrival times based on the navigation request.

When a type of destination is indicated, multiple potential destinations may be determined. The future schedule information can be utilized to determine a required arrival time, or the communication request may indicate the required arrival time. The required arrival time may eliminate some of the potential destinations. The potential destinations may also be ranked in order to facilitate choosing the intermediate and/or final destination(s) from the potential destinations. For example, the past travel information for the passenger(s) may indicate favorite or often-visited potential destinations that are ranked higher than rarely visited or unvisited potential destinations. Further, destination information or qualities may be received and utilized to choose the intermediate and/or final destination(s) from the potential destinations. For example, a destination with a current or estimated destination duration allowing the passenger(s) to still arrive at the final destination by the required arrival time may be ranked higher. As another example, when the passenger qualities indicated by the passenger data or passenger profile(s) indicate a child passenger, casual potential destinations may be ranked higher than formal potential destinations.

Ultimately, the passenger(s) may select one or more of the highest-ranked potential destinations or the top-ranked potential destination(s) may be automatically selected, and a guidance route including the intermediate destination(s) and the final destination is generated. In some embodiments, when an additional passenger enters the vehicle, additional passenger information may be retrieved, and the final destination and/or intermediate destination(s) may be updated based on such additional passenger information. The guidance route may then be updated with the updated final destination and/or the updated intermediate destination(s).

To achieve the foregoing and other objects and advantages, in one aspect, the present subject matter is directed to a system for providing vehicle navigation routing based on passenger habits. The system includes a passenger information module, which includes instructions stored in at least one memory and executable by one or more processors to cause the passenger information module to retrieve one or more of past travel information or future schedule information for one or more passengers of the vehicle. The system also includes a navigation routing module including instructions stored in at least one memory and executable by one or more processors to cause the navigation routing module to receive a navigation request from the passenger(s) of the vehicle. The instructions of the navigation routing module, when executed by the processor(s), further cause the navigation routing module to determine a final destination and an intermediate destination based on the navigation request and the past travel information and/or the future schedule information for the passenger(s). The instructions of the navigation routing module, when executed by the processor(s), also cause the navigation routing module to generate a guidance route including the intermediate destination and the final destination.

In at least one embodiment, the instructions of the passenger information module, when executed by the processor(s), may also cause the passenger information module to assign to each passenger a passenger identification (ID) based on data indicative of the passenger(s) of the vehicle. In additional or alternative embodiments, the past travel information and/or the future schedule information for the passenger(s) of the vehicle may be retrieved from one or more passenger profiles associated with the passenger ID(s). In further or alternative embodiments, each passenger ID may be assigned to each passenger utilizing an artificial intelligence algorithm. Additionally or alternatively, the past travel information and/or the future schedule information for the passenger(s) may be retrieved from one or more mobile devices associated with the passenger(s).

In additional or alternative embodiments, the navigation request may include a natural language statement indicating the final destination and/or the intermediate destination. Additionally or alternatively, the instructions of the navigation routing module, when executed by the processor(s), may also cause the navigation routing module to interpret the natural language statement to identify the final destination and the intermediate destination utilizing an artificial intelligence algorithm. In additional or alternative embodiments, the navigation request may indicate a type of final destination, a type of intermediate destination, or both. In some such embodiments, determining the final destination and the intermediate destination may be further based on the type of final destination and/or the type of intermediate destination. In additional or alternative embodiments, the instructions of the navigation routing module, when executed by the processor(s), may also cause the navigation routing module to determine geographic locations associated with the intermediate location and the final destination. In a further or alternative embodiment, the navigation request, the past travel information for the passenger(s), and/or the future schedule information for the passenger(s) may indicate a required arrival time at the final destination. In some such embodiments, the intermediate destination may be further determined based on the required arrival time at the final destination.

In additional or different embodiments, the passenger(s) include two or more passengers. In some such embodiments, the final destination and/or the intermediate destination may be further determined based on the past travel information and/or the future schedule information for multiple of the passengers. Additionally or alternatively, the instructions of the passenger information module, when executed by the processor(s), may further cause the passenger information module to retrieve past travel information, future schedule information, or both for an additional passenger of the vehicle in response to the additional passenger entering the vehicle subsequent to generating the guidance route. In further or different embodiments, the instructions of the navigation routing module, when executed by the processor(s), may also cause the navigation routing module to determine an updated final destination, an updated intermediate destination, or both based on the past travel information and/or the future schedule information for the additional passenger in response to retrieving the past travel information and/or the future schedule information for the additional passenger of the vehicle. In some such embodiments, the instructions of the navigation routing module, when executed by the processor(s), may further cause the navigation routing module to update the guidance route to include the updated intermediate destination and/or the updated final destination.

In an additional or alternative embodiment, the instructions of the navigation routing module, when executed by the processor(s), may further cause the navigation routing module to determine multiple potential intermediate destinations based on the navigation request and the past travel information and/or the future schedule information for the passenger(s). In some such embodiments, the intermediate destination may be further determined by ranking the potential intermediate destinations based at least in part on the past travel information for the passenger(s). In additional or alternative embodiments, the instructions of the navigation routing module, when executed by the processor(s), may also cause the navigation routing module to receive information indicative of one or more qualities of one or more potential intermediate destinations. Additionally or alternatively, the intermediate destination may be further determined based on the quality(ies) of the potential intermediate destination(s). In further or different embodiments, the quality(ies) of the potential intermediate destination(s) may include one or more of a current availability of one or more potential intermediate destinations, a current estimate of a destination duration for one or more potential intermediate destinations, an availability for a reservation for one or more potential intermediate destinations, or a current or estimated wait time for one or more potential intermediate destinations.

In an additional or alternative aspect, the present subject matter is directed to a non-transitory computer-readable medium comprising instructions stored in at least one memory that, when executed by one or more processors, cause the one or more processors to carry out steps. The steps include retrieving past travel information, future schedule information, or both for one or more passenger(s) of a vehicle. The steps further include receiving a navigation request from the passenger(s) of the vehicle. Another step includes determining a final destination and an intermediate destination based on the navigation request and the past travel information and/or the future schedule information for the passenger(s). The steps also include generating a guidance route including the intermediate destination and the final destination.

In at least one embodiment, the steps may further include assigning to each passenger a passenger identification (ID) based on data indicative of the passenger(s) of the vehicle. In some such embodiments, the past travel information and/or the future schedule information for the passenger(s) of the vehicle may be retrieved from one or more passenger profiles associated with the passenger ID(s). Additionally or alternatively, the steps may include determining multiple potential intermediate destinations based on the navigation request and the past travel information and/or the future schedule information for the passenger(s). In some such embodiments, the intermediate destination may be further determined by ranking the potential intermediate destinations based at least in part on the past travel information for the passenger(s).

In an additional or alternative embodiment, the navigation request may include a natural language statement indicating the final destination and/or the intermediate destination. In some such embodiments, the steps may further include interpreting the natural language statement to identify the final destination and the intermediate destination utilizing an artificial intelligence algorithm. In a further or different embodiment, the navigation request may indicate a type of final destination, a type of intermediate destination, or both. In some such embodiments, determining the final destination and the intermediate destination may be further based on the type of final destination and/or the type of intermediate destination. In a further or different embodiment, the navigation request, the past travel information for the passenger(s), and/or the future schedule information for the passenger(s) may indicate a required arrival time at the final destination. Additionally or alternatively, the intermediate destination may be further determined based on the required arrival time at the final destination.

In additional or alternative embodiments, the steps may further include retrieving past travel information, future schedule information, or both for an additional passenger of the vehicle in response to the additional passenger entering the vehicle subsequent to generating the guidance route. Additionally or alternatively, the steps may include determining an updated final destination, an updated intermediate destination, or both based on the past travel information and/or the future schedule information for the additional passenger in response to retrieving the past travel information and/or the future schedule information for the additional passenger of the vehicle. In an additional or alternative embodiment, the steps may include updating the guidance route to include the updated intermediate destination and/or the updated final destination.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the companying drawings, in which:

FIG. 1 illustrates a schematic diagram of an exemplary embodiment of a system for providing vehicle navigation routing based on passenger habits, in accordance with aspects of the present subject matter;

FIG. 2 illustrates a schematic logic diagram of an exemplary embodiment of a system for providing vehicle navigation routing based on passenger habits, in accordance with aspects of the present subject matter;

FIG. 3 illustrates an exemplary embodiment of a method for providing vehicle navigation routing based on passenger habits, in accordance with aspects of the present subject matter;

FIG. 4 illustrates an exemplary embodiment of a visual indicator of ranked potential destinations, in accordance with aspects of the present subject matter;

FIG. 5 illustrates a schematic diagram of an exemplary embodiment of a network of a cloud-based system for implementing various cloud-based services, in accordance with aspects of the present subject matter;

FIG. 6 illustrates a schematic diagram of an exemplary embodiment of a server which may be used in the cloud-based system of FIG. 5 or stand-alone, in accordance with aspects of the present subject matter; and

FIG. 7 illustrates a schematic diagram of an exemplary embodiment of a user device which may be used in the cloud-based system of FIG. 5 or stand-alone, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

The terms “passenger” or “passengers” and the like refer to any occupant or occupants, respectively, of a vehicle including the operator or driver.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, embodiments of the disclosed systems and methods facilitate choosing destinations based on a navigation request from one more passengers of a vehicle and the qualities, past travel information, and/or schedule requirements of the passenger(s). A passenger information module and associated method elements may retrieve passenger information, such as passenger qualities, past travel information for the passenger(s), and/or future schedule information for the passenger(s). For example, such passenger information may be retrieved from one or more personal devices, mobile devices, cell phones, or the like of the passenger(s). In another example, the passenger(s) may be identified and associated with one or more passenger profiles, and some or all of the passenger information may be retrieved from the associated passenger profile(s). In some such embodiments, the passenger information module and associated method elements can identify the passenger(s) of the vehicle, the number of passengers, and/or assign passenger identifications (passenger IDs) based on passenger data indicating the passenger(s), such as vehicle sensor data and/or data retrieved from the personal device(s) of the passenger(s). Such determinations may be made utilizing appropriate artificial intelligence algorithms and/or by comparing qualities or features of the passenger(s) indicated by the passenger data and/or passenger profile(s).

A navigation routing module and associated method elements can receive the navigation request (e.g., a natural language statement, spoken command, or the like) from the passenger(s) of the vehicle and determine a final destination and one or more intermediate destinations based on the navigation request and the passenger information (e.g., the passenger qualities, the past travel information for the passenger(s), and/or the future schedule information for the passenger(s)). For example one or more suitable artificial intelligence algorithms or natural language processing algorithms may identify the final destination, the intermediate destination(s), types of such destinations (e.g., coffee places, breakfast restaurants, convenience stores, pharmacies, etc.), and/or one or more required arrival times based on the navigation request.

When a type of destination is indicated, multiple potential destinations may be determined. The future schedule information can be utilized to determine a required arrival time, or the communication request may indicate the required arrival time. The required arrival time may eliminate some of the potential destinations. The potential destinations may also be ranked in order to facilitate choosing the intermediate and/or final destination(s) from the potential destinations. For example, the past travel information for the passenger(s) may indicate favorite or often-visited potential destinations that are ranked higher than rarely visited or unvisited potential destinations. Further, destination information or qualities may be received and utilized to choose the intermediate and/or final destination(s) from the potential destinations. For example, a destination with a current or estimated destination duration allowing the passenger(s) to still arrive at the final destination by the required arrival time may be ranked higher. As another example, when the passenger qualities indicated by the passenger data or passenger profile(s) indicate a child passenger, casual potential destinations may be ranked higher than formal potential destinations.

Ultimately, the passenger(s) may select one or more of the highest-ranked potential destinations or the top-ranked potential destination(s) may be automatically selected, and a guidance route including the intermediate destination(s) and the final destination is generated. In some embodiments, when an additional passenger enters the vehicle, additional passenger information may be retrieved, and the final destination and/or intermediate destination(s) may be updated based on such additional passenger information. The guidance route may then be updated with the updated final destination and/or the updated intermediate destination(s).

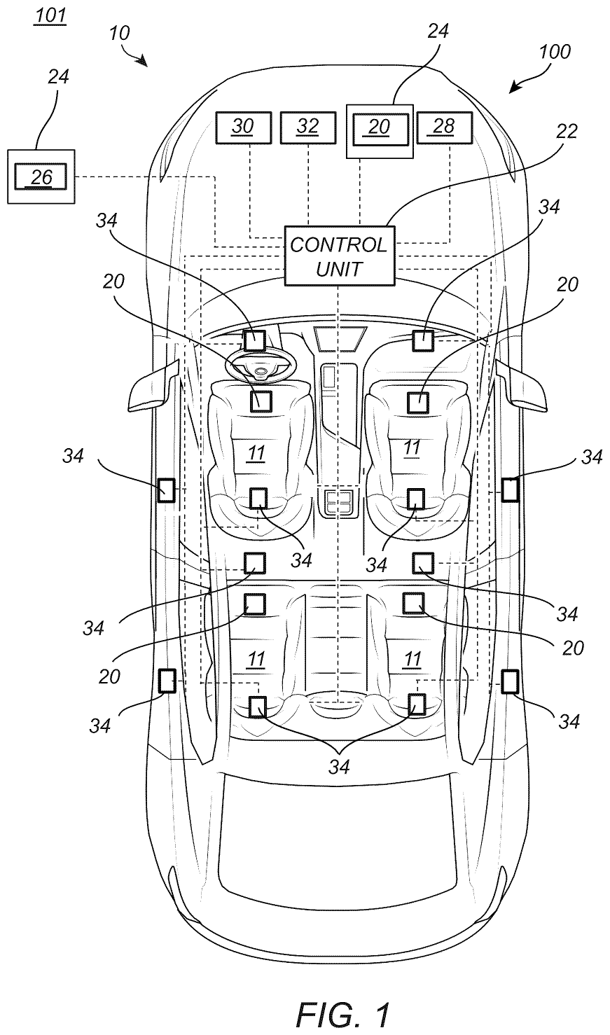

Referring now generally to FIG. 1, a schematic diagram of an exemplary embodiment of a system for providing vehicle navigation routing based on passenger habits is illustrated in accordance with aspects of the present subject matter. As shown, a vehicle 10 may generally include system (system 100) for controlling vehicle navigation (e.g., via vehicle navigation system 28), and/or one or more passenger sensors 34 (e.g., internal vehicle cameras, microphones, seat sensors, or the like) based on passenger habits (e.g., as indicated by past travel information) and/or based on scheduling requirements of the passengers, as described herein. For example, the system 100 may include one or more passenger sensors 34 (e.g., a microphone and camera for each seat assembly 11 provided in the vehicle 10).

While each seat assembly 11 of FIG. 1 is illustrated with one or more dedicated passenger sensors 34, some vehicles 10 and/or systems 100 may not include a passenger sensor 34 or multiple passenger sensors 34 for each seat assembly 11. For example, only a portion of the seat assemblies 11 may be provided with a dedicated microphone, such as some but not all of the rear seat assemblies 11. In some embodiments, adjacent seat assemblies 11 may share a microphone and/or a camera configured for use with embodiments of the system 100 described herein. Furthermore, at least some of the passengers seated within the vehicle 10, such as the passenger of each seat assembly 11 may have a mobile device 20 (e.g., a cellular phone, tablet, laptop, MP4/MP3 audio device, or the like). Embodiments of the system 100 disclosed herein may utilize the mobile device(s) 20 of the passengers to determine passengers' identifications and/or to retrieve past travel information and/or future schedule information for one or more of the passengers of the vehicle 10. Thus and in such embodiments, the passenger sensor(s) 34 may include one more receivers/transceivers suitable to establish a wired or wireless connection (e.g., a local area network connection, a Wi-Fi connection, a Bluetooth connection, or the like) between the vehicle 10, the system 100, and/or an associated control unit 22 and the mobile device(s) 20 of the passenger(s).

In some embodiments, the vehicle 10 may be an electric vehicle having electrical components (e.g., batteries) for propelling the vehicle 10. Alternatively, the vehicle 10 may be configured with a rear-mounted or front-mounted internal combustion engine. In other embodiments, the vehicle 10 may be configured as a hybrid vehicle, which is driven by both a petroleum product (e.g., gas, diesel, jet fuel, and the like) and electrical power. It will be appreciated that the exemplary vehicle(s) 10 depicted and described herein are by way of example only, and, in other exemplary embodiments, the vehicle 10 may have any other suitable configuration, including, for example, any other suitable number of rows of seats, rows of doors, etc. and associated passenger sensors 34 and/or mobile devices 20 provided for some and up to all of the seat assemblies 11. Additionally or alternatively, in other exemplary embodiments, any other suitable power sources may be provided. For example, the vehicle 10 may include a liquid or gaseous hydrogen powered engine, a gas turbine engine, an inboard motor, an outboard motor, etc.

While embodiments of the vehicle 10 herein may be illustrated or described as an automotive vehicle, it should be appreciated that the present disclosure is equally applicable to any other form of transportation (e.g., trains, rotary-wing aircraft, fixed-wing aircraft, boats, busses, ferries, passenger rail cars, public transportation, and the like) where vehicle navigation routing based on passenger habits and/or schedule requirements is desired. Additionally or alternatively, embodiments of the present subject matter may be utilized with multiple vehicles 10. For example, a proposed navigation route may generally include driving to a public transportation stop (e.g., a parking garage provided for a District of Columbia Metro stop), taking the public transportation to a first destination or waypoint, walking or utilizing a ride share program to travel to an intermediate destination (e.g., a breakfast or coffee establishment), and/or walking, utilizing public transportation, utilizing a ride sharing program, etc. to travel to a final destination (e.g., work). Thus, regardless of the type of power train, design, or model of the vehicle(s) 10, the vehicle(s) 10 may include or be utilized with embodiments of the system 100, as described herein.

As shown, the vehicle 10 and/or system 100 may further include a control unit 22 (e.g., an electronic control unit, multiple associated control units, and/or a combination of one or more processing devices and at least one memory or memory device as described herein) communicatively coupled to the passenger sensor(s) 34, the vehicle navigation system 28, and/or the mobile device(s) 20 of one or more of the seat assemblies 11, such as all of the seat assemblies 11, and configured to direct operation of one or more of such components in accordance with aspects of the present subject matter. While a single control unit 22 is illustrated in FIG. 1 for simplicity, it should be appreciated that the control unit 22 may include multiple associated control units that together are configured to provide operational control of the vehicle 10, components or systems of the vehicle 10, system 100, the passenger sensor(s) 34, and/or the vehicle navigation system 28.

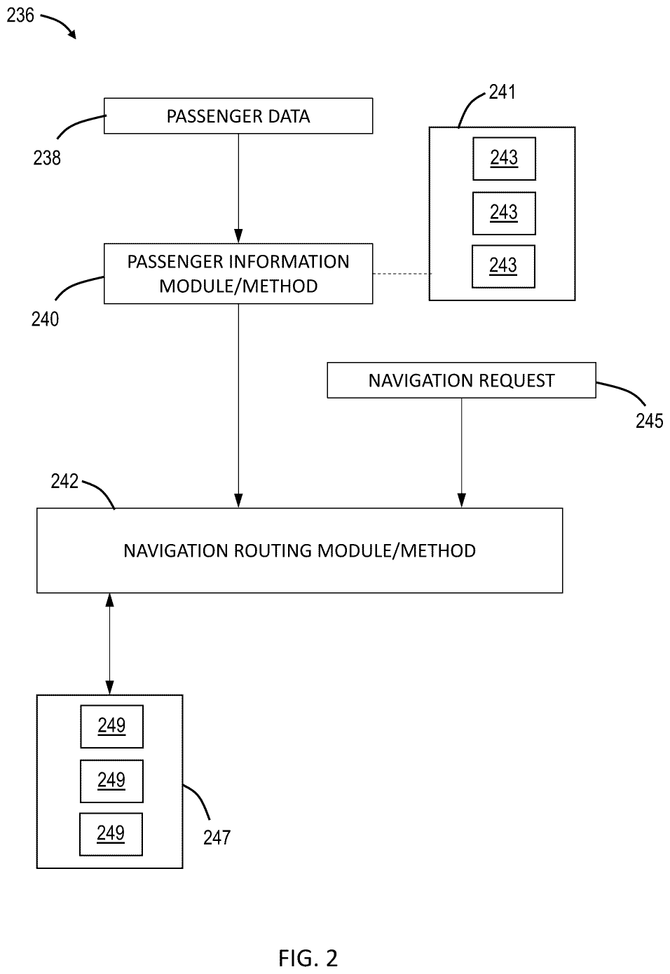

The control unit 22 may additionally or alternatively facilitate communication between the system 100, the passenger sensor(s) 34, the vehicle navigation system 28, and/or the mobile device(s) 20 associated with one or more of the seat assemblies 11. Generally, the control unit 22 may be configured to receive data indicative of the passengers of the vehicle, to assign passenger identifications (passenger IDs) based on such data, and to retrieve past travel information and/or future travel information from passenger profiles associated with the passenger ID(s) for one or more passengers, such as for some of the passengers, such as all of the passengers of the vehicle 10. Alternatively, the past travel information and/or future travel information for one or more passengers may be retrieved from the mobile device(s) 20 associated with the passenger(s). For example, in response to a navigation request 245 (see FIG. 2) indicating a final destination and an intermediate destination (e.g., I want to pick up coffee on the way to work), the control unit 22 may determine a coffee shop (e.g., a coffee shop the passenger(s) enjoys based on the past travel information) on the way to work (e.g., based on the past travel information or indicated in the passenger profile(s)) that allows the passenger(s) to arrive at work by a known start time (e.g., based on the future travel information) or determined start time (e.g., based on past travel information).

Thus and as shown in FIG. 1., the control unit 22 may provide operational control of the passenger sensor(s) 34, the vehicle navigation system 28, and/or the mobile device(s) 20 associated with one or more of the passengers of the vehicle 10 and/or may be communicatively coupled with various additional or alternative components of the vehicle 10 or components associated with the vehicle 10, as described in more detail below. While some communication links in FIG. 1 may be illustrated as joint communication links, it should be appreciated that one or more components communicatively coupled to the control unit 22, such as all of the components, may have component dedicated communication links (e.g., wireless or wired communication links with the control unit 22).

In some embodiments and as shown, the control unit 22 may include or be communicatively coupled with one or more external devices 24 (such as any of the mobile devices 20 described herein). The external device(s) 24 may communicate inputs to the control unit(s) 22 utilized to control operation of the system 100, the passenger sensor(s) 34, the vehicle navigation system 28, and/or the mobile device(s) 20 associated with one or more of the passengers of the vehicle 10. As also shown in FIG. 1, the external device(s) 24 communicatively coupled to the control unit(s) 22 may include one or more remote servers, processing units, memory devices, computing devices, or the like (e.g., one or remote computing device 26).

By applying an appropriate algorithm in the control unit 22, the system 100 can be integrated with the rest of the vehicle systems, with input from/output to the vehicle navigation system 28, a vehicle power supply 30, an infotainment unit or system (infotainment unit 32), one or more passenger sensors 34 (e.g., internal passenger sensors and/or external passenger sensors as illustrated), and/or one or more external devices 24, such as the remote computing device(s) 26 and/or mobile device(s) 20, that includes a mobile application and/or a cloud application configured to provide external information to the control unit 22, such as passenger profile information and/or instructions associated with a passenger information module/method and/or potential destination information (e.g., destination quality information) and/or instructions associated with a navigation routing module/method, as described in more detail herein.

In some embodiments, besides controlling the operation of the system 100 or components thereof, components of the vehicle 10 such as the passenger sensor(s) 34 and vehicle navigation system 28, and/or the mobile device(s) 20 associated with one or more of the passengers of the vehicle 10, the control unit 22 may also provide useful information to the driver, either directly to the infotainment unit 32, such as a display thereof, or the external device(s) 24, such as a user interface thereof. The user interface of the external device(s) 24 and/or the infotainment unit 32 may include one or more buttons, switches, touch screen capability, or the like allowing a user, passenger, operator, etc. to communicate inputs to the control unit 22 utilized to control operation of the system 100 or components thereof and/or components of the vehicle 10 such as the passenger sensor(s) 34 and the vehicle navigation system 28.

As shown, the system 100 and/or vehicle 10 may include one or more seat sensor (e.g., passenger sensor(s) 34), such as one seat sensor associated with each seat assembly 11 of the vehicle 10. Some embodiments of the seat sensor may include a sensor, circuit, or the like suitable to communicate a signal indicative of whether the associated seat assembly 11 is occupied or empty. For example, a suitable seat sensor may be configured to communicate a signal indicating pressure or weight on the seat, which may indicate at occupied seat assembly 11. Additionally or alternatively, a suitable seat sensor may be configured to communicate a signal indicating use of an associated seat belt, which may indicate at occupied seat assembly 11.

As shown, the vehicle 10 and/or system 100 may include one or more additional or alternative passenger sensors 34, such as one or more internal passenger sensors 34 associated with each seat 11 of the vehicle 10, as shown, and/or one or more external passenger sensors 34 for each door or entry to the vehicle 10. The passenger sensor(s) 34 may generally be configured to communicate one or more signals indicative of, without limitation, one or more qualities of a passenger seated within an associated seat assembly 11 of the vehicle 10, one or more qualities of a potential passenger about to enter the vehicle 10, and/or one or more qualities of a passenger in the process of being seated in a seat assembly 11. For instance, the passenger sensor(s) 34 may communicate data indicative of, but not limited to, height; skin tone; hair color, hair length, hair style, or degree of baldness; clothing style; the passenger's voice and/or speech patterns; passenger weight or BMI estimation; passenger behavior; passenger physical challenges, disabilities, assistive technologies, injuries, etc.; and/or the identity of the passenger. The passenger sensor(s) 34 may include, without limitation, one or more microphones, audio sensors, cameras, optical sensors, RADAR sensors, LIDAR sensors, inferred sensors, other sensors suitable to transmit and/or receive suitable electromagnetic signals/waves, acoustic sensors, RFID transceivers/receivers, proximity sensors, a seat sensor (e.g., a weight sensor embedded or provided in association with the seat 11), and/or the like.

With respect to external embodiments of the passenger sensor(s) 34. Such external passenger sensor(s) 34 may generally be configured to communicate one or more signals indicative of, without limitation, that a passenger has approached an associated door of the vehicle 10; one or more qualities of a passenger within proximity of the door (e.g., height; skin tone; hair color, hair length, hair style, or degree of baldness; clothing style; passengers voice and/or speech patterns; passenger weight or BMI estimations; passenger behavior; passenger physical challenges, disabilities, assistive technologies, injuries, etc.; and/or the identity of the passenger).

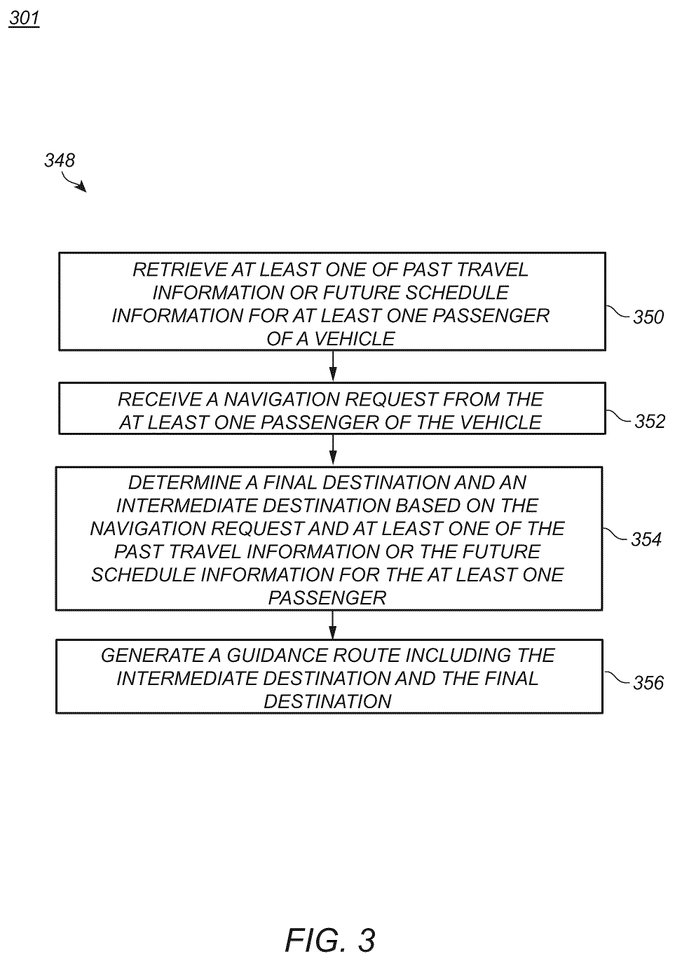

Referring now to FIGS. 2-3, FIG. 2 illustrates a schematic logic diagram of an exemplary embodiment of a system for providing vehicle navigation routing based on passenger habits, in accordance with aspects of the present subject matter, and FIG. 3 illustrates one exemplary embodiment of a method for providing vehicle navigation routing based on passenger habits, in accordance with aspects of the present disclosure. The logic diagram depicted in FIG. 2 (control logic 236) and/or the method or process (method 348) depicted in FIG. 3 may be utilized to control or in association with embodiments of the vehicle 10, the system 100, the passenger sensor(s) 34 (e.g., one or more cameras and microphones), and/or the vehicle navigation system 28, as described with respect to FIG. 1 and/or other similar or suitably configured vehicles, systems for or providing vehicle navigation routing based on passenger habits, passenger sensors, microphones, speakers, and/or mobile devices. The control logic 236 may include one or more modules including instructions stored in at least one memory and executable by one or more processors to cause the processor(s) to implement steps, method elements, or the like as described herein. For example, elements of the control logic 236 and/or method 348 may be implemented, at least in part, by the control unit 22 and stored in memory associated with the control unit 22 and/or included with or accessible by the vehicle 10.

As shown, the control logic 236 may include a passenger information module and/or method (passenger information module 240) configured to determine the number of passengers of the vehicle, identify the passengers, and/or retrieve passenger information such as passenger quality information, past travel information, and/or future schedule information. Such determination(s) may be based on data indicative of one or more passenger qualities (e.g., passenger data 238) of a passenger seated in, about to be seated in, and/or associated with a seat assembly 11 of the vehicle 10. For example, the passenger information module 240 may receive the passenger data 238 indicative of a one or more passengers seated within the vehicle. The method 348 may include and/or the passenger information module 240 may be configured to determine, based on the received passenger data 238, a number of passengers seated within the vehicle 10. In some situations and/or embodiments, passenger data 238 may include an indication that the system 100 and/or control unit 22 has been communicatively coupled to one or more mobile devices 20 of the passenger(s). The coupling of the control unit 22 with the mobile device(s) 20 may indicate, at least, a minimum number of passengers of the vehicle 10 and/or position(s) of the associated passenger(s) within the vehicle 10 (e.g., for a wired connection between the system 100/vehicle 10 and the mobile device(s) 20).

Some configurations of the method 348 may include and/or the passenger information module 240 may be configured to retrieve the past travel information and/or the future schedule information of the passenger(s) of the vehicle, see, e.g., method element 350. In some embodiments, the passenger data 238 may include data retrieved from the mobile device(s) 20 indicative of a given name(s) or nickname(s) of the associated passenger(s), past-utilized or previously indicated preferred seat assembly(ies) 11 of the passenger(s), one or more qualities of the passenger(s), past travel information for the passenger(s), and/or future schedule information for the passenger(s). It should be appreciated that any deficiencies in identifying the number, identity, qualities, past travel information, and/or future schedule information of the passenger(s) of the vehicle 10 may be cured utilizing appropriate portions of other procedures described herein, such as the below description.

In some embodiments of the control logic 236, the passenger data 236 may be communicated from one or more of the passenger sensors 34 (e.g., one or more internal passenger sensors and/or external passenger sensors), as described herein, and/or the external device(s) 24 (e.g., the remote computing device(s) 26, mobile device(s) 20, and/or other suitably configured external computing device(s) that include a mobile application and/or a cloud application configured to provide external information to the control unit 22).

The method 348 may include and/or the passenger information module 240 may be configured to assign to each passenger a passenger identification (ID) based on the passenger data 238 of the passenger(s) seated within the vehicle 10. Additionally or alternatively, the passenger ID(s) may be assigned to the passenger(s) (e.g., at least one passenger, at least a portion of the passengers, or all of the passengers) utilizing an artificial intelligence algorithm. In at least one embodiment, the passenger information module 240 and/or associated method 348 may include or be associated with one or more artificial intelligence programs. For example, the number of passengers may be determined and/or the passenger IDs may be assigned to the passengers utilizing the artificial intelligence algorithm(s) and based on the passenger data 238 indicative of the passenger quality(ies) of the passenger(s) seated within the associated seat assembly(ies) 11 of the vehicle 10, one or more qualities of one or more potential passengers about to enter the vehicle 10, and/or one or more qualities of one or more passengers in the process of being seated in respective seat assemblies 11 of the vehicle 10.

The artificial intelligence algorithms(s) may include one or more algorithms, programs, modules, and the like suitable to simulate intelligence human behavior or perform tasks historically requiring human implementation. For example, the artificial intelligence algorithms may include, without limitation, one or more of machine learning algorithms, artificial neural networks, recurrent artificial neural networks, feedforward neural networks, convolutional neural networks, recurrent neural networks, deep neural networks, natural language processing algorithms, long short term memory networks, inductive logic programming algorithms, support vector machines, clustering algorithms, Bayesian networks, reinforcement learning algorithms, representation learning algorithms, similarity and metric learning algorithms, sparse dictionary learning algorithms, genetic algorithms, k-nearest neighbor (KNN) algorithms, decision tree learning algorithms, association rule learning algorithms, and the like. Some of the artificial intelligence algorithms described herein may be trained (via a supervised or unsupervised training process) based on training data provided to the artificial intelligence algorithms. Thus, the artificial intelligence algorithm(s) may generally be utilized to determine the number of passengers in the vehicle 10, the positions of the passengers of the vehicle, and/or a passenger ID of each passenger of the vehicle based at least in part on the passenger data 238 indicative of the passenger quality(ies).

As shown particularly in FIG. 2 and for some embodiments, the passenger information module 238 may be communicatively coupled to a passenger profile repository 241 (e.g., as stored in one or more memories, memory devices, or the like as described herein). The passenger profile repository 241 may include data associated with multiple passenger profiles 243. While three passenger profiles 243 are included for illustrative purposes in FIG. 2, it should be appreciated that the passenger profile repository 241 may include data associated with numerous additional passenger profiles 243 or fewer passenger profiles 243. In some embodiments, the passenger profile repository 241 may only include data of passenger profiles 243 associated with the vehicle 10 and/or with an operator, owner, etc. of the vehicle 10. However, the passenger repository 241 may include passenger profiles 243 associated with different vehicles 10 and/or different operators, owners, etc. For example, some embodiments of the system 100, control logic 236, and/or associated method 348 may allow for accessing passenger qualities of a guest passenger of a different vehicle indicated by the passenger profile 243 of the guest passenger and stored in a joint or master passenger profile repository 241. Additionally or alternatively, the passenger profile(s) may be retrieved from one or more suitable remote computing devices 26, one or more mobile devices 20 of the passenger(s), one or more storage devices included in the vehicle 10, and/or one or more storage devices included in one or more other, suitably configured vehicles. In some additional or alternative embodiments, the passenger quality data and/or the passenger quality data associated with the passenger profiles 243 stored in the passenger profile repository 241 may be utilized to train suitable artificial intelligence algorithms of the passenger information module 240.

In some embodiments, the passenger information module 240 may compare the passenger data 238 indicative of the passenger quality(ies) of a passenger with multiple passenger profiles 243 and identify the passenger profile 243 associated with the passenger data 238 indicative of the passenger quality(ies) in order to determine the passenger ID of the passenger and/or the seat assembly 11 that the passenger occupies or is about to occupy. For example, the passenger information module 240 may make such determination(s) based on the passenger data 238 indicative of the passenger quality(ies) and a history of passenger behavior indicated by the associated passenger profile 243 identified as associated with the respective passenger. In some embodiments, the data of the history of passenger behavior indicated by the passenger profile(s) 243 may include past-utilized or previously indicated preferred seat assembly(ies) 11 of the passenger(s) and/or the specific vehicle door(s) utilized by such passenger(s) in the past. Thus and in various embodiments, assigning the passenger identification ID to a passenger of the vehicle 10 may include assigning a given name, nickname, or the like associated with the passenger profile 243 determined to be associated with the passenger in question.

In various embodiments, once a passenger profile(s) 243 of a passenger(s) has been identified, information may be retrieved from the passenger profile(s) 243 indicating the past travel information, the future schedule information, or both of the associated passengers. In some situations, one or more passengers may not have a mobile device 20 to retrieve the past travel information and/or the future schedule information or the mobile device may not include such information. In other situations, the past travel information and/or the future schedule information retrieved from the passenger profile(s) 243 may include additional information not provided via the mobile device(s) 20 and/or vice-versa. It should be appreciated that the past travel information and/or the future schedule information stored in the passenger profile 243 and the mobile device 20 of a passenger may be duplicative, and such information may be retrieved from only one such source. Optionally, the other source may be utilized to verify the retrieved information. For example, consumer calendars indicating future schedule information (e.g., Google® Calendar, Microsoft® Calendar, and the like) and/or travel histories, reports, timelines, and the like (timeline history) indicating past travel information may be linked or synced such that any device with access to the calendar and/or timeline history receives updates provided via any other device that also has access to the calendar and/or timeline history. Thus, information of the passenger profile(s) 243 (such as the past travel information and/or the future schedule information) may have already been synced with updates to such information generated at or included in the mobile device(s) 20. Regardless of the source of the past travel information and/or the future schedule information, such information may be communicated to a navigation routing module and/or method (navigation routing module 243) and/or utilized in the method 348 to generate a navigation route based, at least in part, on such information.

Referring again generally to FIGS. 2-3, the control logic 236 may include the navigation routing module 242 configured receive passenger navigation requests 245 and generate guidance route based on such navigation requests 245 and the received past travel information and/or the future schedule information. For example, the method 348 may include and/or the navigation routing module 242 may be configured to receive the navigation request 245 from the passenger(s) of the vehicle, see e.g., method element 352. In some embodiments, the communication request may include a natural language statement sensed via the passenger sensor(s) 34 (e.g., one or more microphones) indicative of one or more of the final destination or the intermediated destination(s). For example, such natural language statement may include or be similar to “We want to stop for breakfast on the way to work,” “Navigate to a coffee shop and then to work,” “Take me to the pharmacy around the corner from John's house, then to John's house, and then to David's house,” or the like. As illustrated in the above examples, the one or more of the final destination and/or intermediate destination(s) may be associated with one correct location (e.g., work, the pharmacy around the corner from John's house, John's house, David's house, and the like). Additionally or alternatively, the final destination and/or intermediate destination(s) may indicate one or more types of destinations (e.g., breakfast, a coffee shop, or the like).

Thus, some embodiments of the navigation routing module 242 and/or associated method 348 may include or be associated with one or more artificial intelligence algorithms (e.g., one natural language processing algorithms) configured to identify the final destination, the intermediate destination(s), the type of final destination, and/or the type(s) of intermediate destination(s) from the natural language statement. Thereafter, the method 348 may include and/or the navigation routing module 242 may be configured to determine the final destination and/or the intermediate destination(s) based on the navigation request 245 and the past travel information and/or the future schedule information for the passenger(s), see, e.g., method element 354. For example, the past travel information for the passenger(s) may indicate geographical locations of work, the pharmacy around the corner from John's house, John's house, David's house, or the like. It should be appreciated that, for a vehicle 10 with multiple passengers, the final destination and/or the intermediate destination may be determined based on the past travel information and/or the future schedule information for multiple of the passengers, such as all of the passengers with available past travel information and/or the future schedule information.

Furthermore, the past travel information for the passenger(s) may indicate a required arrival time at the final destination (e.g., the passenger(s) always arrive at the geographical location of work by 9:00 am). Additionally or alternatively, the future schedule information for the passenger(s) may indicate a required arrival time at work (e.g., work starts at 9:00 am on the passenger's(s') calendar(s) and/or the passenger's(s') calendar(s) indicate a 9:00 am meeting). Additionally or alternatively, the navigation request 245 may indicate a required arrival time at the final destination. For example, the passenger(s) may provide a natural language statement along the lines of “Take us to a convenience store and then to work by 9:30.” It should be appreciated that the required arrival time at the final destination may be indicative of or utilized to determine a maximum destination duration for each intermediate destination allowing the passenger(s) to arrive at the final destination by the required arrival time.

As mentioned above, the navigation request 245 may indicate the type(s) of intermediate destination(s) and/or the type of final destination. In such situations, the method 348 may include and/or the navigation routing module 242 may be configured to determine the final destination and/or the intermediate destination(s) based on the type(s) of destination(s) indicated in the navigation request. For example and as described in more detail below, the final destination and/or the intermediate destination(s) may be determined or selected from multiple potential destinations.

It should be noted that determining and/or selecting the final destination and/or the intermediate destination(s) from multiple potential destinations may also be assisted by an artificial intelligence program, based on the past travel information, and/or based on the future schedule information. As an example, the navigation request 245 may indicate the intermediate destination type is a breakfast restaurant. In such a situation, the method 348 may include and/or the navigation routing module 242 may be configured to determine multiple potential intermediate destinations (breakfast restaurants) based on the navigation request 245 and the past travel information and/or the future schedule information for the passenger(s). It should be appreciated that the potential intermediate destinations may be a subset of all of the applicable destinations in the area having the intermediate destination type indicated by the navigation request 245. For instance, the potential intermediate destinations may only include destinations allowing the passengers travel to the respective destination and still arrive at the final destination by the required arrival time indicated by the navigation request 245, the past travel information of the passenger(s), and/or the future schedule information. Additionally or alternatively, the potential destinations may only include destinations previously visited by one or more of the passengers, as indicated by past travel information of the passenger(s). Alternatively, the potential destinations may include one or more destinations that are not indicated by the past travel information of the passenger(s). For example, the potential destinations may require a minimum number of potential destinations (e.g., ten or more potential destinations, seven or more potential destinations, five or more potential destinations, or three or more potential destinations). Such unvisited locations may be included in the potential destinations to meet the minimum number of potential destinations.

Exemplary embodiments and procedures are described below for determining the intermediate destination(s) from the potential intermediate destinations and generating guidance routes including the same. However, it should be appreciated that the following description is equally applicable to determining the final destination from potential final destinations and generating guidance routes including the same.

In some situations and configurations, the potential intermediate destinations may be further determined based, at least in part, on a health of the vehicle 10, a remaining fuel level or charge of the vehicle 10, or the like as provided to the navigation routing module 242 and/or control unit 22. For example, if the remaining fuel level or charge is not sufficient to travel to a prospective intermediate destination and the final destination, such location may not be included in the potential intermediate destinations. Alternatively, if such a prospective intermediate destination provides vehicle charging to customers or there is nearby charging available, the location may still be included in the potential intermediate destinations. Once the potential intermediate destinations have been determined (e.g., prospective intermediate destinations meeting or allowing for minimum travel requirements), the method 348 may include and/or the navigation routing module 242 may be configured to determine the intermediate destination(s) by ranking the potential intermediate destinations based, at least in part, on the past travel information for the at passenger(s).

In various embodiments, one or more suitably configured and/or trained artificial intelligence algorithms determine the intermediate destination(s) from the potential intermediate destinations and/or rank the potential intermediate destinations. For instance or in alternative embodiments, the method 348 may include and/or the navigation routing module 242 may be configured to rank the potential intermediate destinations based at least in part on the past travel information for the passenger(s). In several instances, the intermediate destination(s) may be determined utilizing such ranking. For example, the method 348 may include and/or the navigation routing module 242 may be configured to rank potential intermediate destinations higher based on the relative number of visits to the respective potential intermediate destinations. Further or alternatively, the method 348 may include and/or the navigation routing module 242 may be configured to rank higher the potential intermediate destinations allowing for arrival to the final destination by the required arrival time, e.g., based on the duration of previous trips to the potential intermediate destination as indicated by the past travel information for the passenger(s).

In additional or alternative embodiments, the method 348 may include and/or the navigation routing module 242 (or associated artificial intelligence algorithm(s)) may be configured to determine the intermediate destination(s) based on one or more qualities of the potential intermediate destination. For instance, the method 348 may include and/or the navigation routing module 242 may be configured to receive information indicative of one or more qualities of the potential intermediate destination(s). In some embodiments and as shown in FIG. 2, the navigation routing module 242 may be communicatively coupled to a destination profile repository 247 (e.g., as stored in one or more memories, memory devices, or the like as described herein). The destination profile repository 247 may include data associated with multiple destination profiles 249. While three destination profiles 249 are included for illustrative purposes in FIG. 2, it should be appreciated that the destination profile repository 247 may include data associated with numerous additional destination profiles 249, e.g., some, most, or all the potential destinations in a region of the vehicle 10 and/or a region of any already determined final or intermediate destinations (e.g., within 5 miles, within 10 miles, or within 15 miles). Additionally or alternatively, the destination profile(s) 249 may be retrieved from one or more suitable remote computing devices 26 or one or more mobile devices 20 of the passenger(s).

In various embodiments, once the destination profiles 249 of the potential intermediate destinations have been identified, information may be retrieved from the destination profiles 249 indicating one or more qualities of each potential intermediate destination associated with a destination profile 249. Generally, the method 348 may include and/or the navigation routing module 242 (e.g., via one or more associated artificial intelligence programs) may be configured to rank the potential intermediate destinations based on the retrieved qualities of the potential intermediate destinations and/or to generate a navigation route based, at least in part, on such information. In various embodiments, information communicated from the destination profile repository 247 and/or the destination profiles 249 indicating the qualities of the potential intermediate destination may include, but are not limited to, one or more of a current availability of the potential intermediate destination(s), a current estimate of a destination duration for the potential intermediate destination(s), a current/estimated wait time(s) or predicted future wait time(s) at the potential intermediate destination(s), the availability of drive-up or on-the-go services of the potential intermediate destination(s), a current estimate of a sit-down destination duration for the potential intermediate destination(s), a current estimate of drive-up or on-the-go services of the potential intermediate destination(s), types of or individual goods (e.g., the restaurant has chicken nuggets for picky passenger John) or services provided by the intermediate destination(s), the availability of vehicle charging at or near the potential intermediate destination(s), the atmosphere (e.g., formal or casual) of the potential intermediate destination(s), the operating times of the potential intermediate destination(s), and/or reservation availability for the potential intermediate destination(s).

In additional or alternative embodiments, the method 348 may include and/or the navigation routing module 242 (or associated artificial intelligence algorithm(s)) may be configured to determine the intermediate destination(s) based on one or more qualities of the passengers, e.g., as indicated by the passenger data 238 and/or the passenger profiles 243. For example, the method 348 may include and/or the navigation routing module 242 may be configured to rank casual potential intermediate destinations higher if one of the passengers is a child, as indicated by the passenger data 238 and/or the associated passenger profile 243. As another example, if the passenger data 238 indicates that passenger Frank is wearing a shirt with script such as “Fur is Murder,” “PETA®,” or the like, potential intermediate destinations having vegetarian options or more vegetarian options may be ranked higher than intermediate potential having no vegetarian options or fewer vegetarian options. Similarly, dietary restrictions or preferences indicated by the passenger profiles(s) 243 (e.g., a peanut allergy, a practicing catholic that does not eat meat on Fridays during Lent, membership in PETA®, etc.) may additionally or alternatively be utilized to rank the potential intermediate destinations.

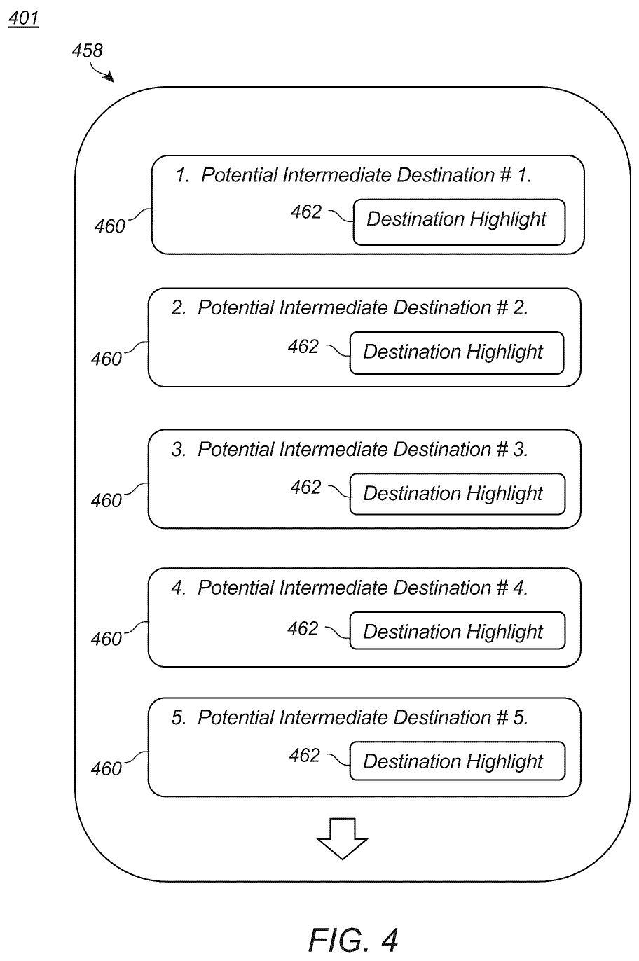

Once the potential intermediate destinations have been determined and ranked, the highest ranked potential intermediate destination may automatically be selected as the intermediate destinations, at least for some embodiments. Alternatively, the top-ranked potential intermediate destinations may be provided to the passenger(s), allowing the passenger(s) to select the intermediate destination. Referring now to FIG. 4, an exemplary embodiment of a visual indicator and/or a graphical user interface of ranked potential intermediate destinations is illustrated in accordance with aspects of the present subject matter. For example, the selection of the intermediate destination may be a vehicle interface input (e.g., infotainment unit 32 selection, a touchscreen interaction, button selection, dial selection, etc.) and/or a mobile device interface input with respect to a graphical user interface including a visual indicator 458 of the top-ranked potential intermediate destinations (potential destinations 460). Additionally or alternatively, the passenger(s) may select the intermediate destination from the potential destinations 460 via a natural language statement, e.g., as sensed by the passenger sensor(s) 34 and/or as interpreted by the navigation routing module 242 (e.g., one or more artificial intelligence programs or natural language processing algorithms thereof).

While the exemplary visual indicator 458 includes five potential destinations 460, the visual indicator 458 and/or graphical user interface may display additional or fewer potential destinations 460 or may be navigable to display additional potential destinations 460. As shown in FIG. 4 and in some embodiments, one more of the potential destinations 460 may include a destination highlight 462 indicating one or more factors that resulted in including the potential destination in the top-ranked potential destinations. Such destination highlights 462 may indicate destination quality information retrieved from the destination profiles 249 (e.g., available vehicle charging, available reservations, numerous vegetarian options, destination atmosphere, etc.). Additionally or alternatively, such destination highlights 462 may indicate information determined from the past travel information and/or the future schedule information of the passenger(s). For instance, the destination highlight 462 may indicate that a potential destination is the favorite of or often visited by the passenger(s) (e.g., most visited by passenger John, John's favorite coffee place, most visited by the group, etc.). Additionally or alternatively, the destination highlight 462 may indicate that a potential intermediate destination allows for arriving at the final destination by the required arrival time and/or that a potential destination allows for arriving at the final destination early.

Thus, the method 348 may include and/or the navigation routing module 242 may be configured to generating the visual indicator 458 for each of the top-ranked potential intermediate destinations (e.g., potential destinations 460) via at least one display integrated with the vehicle 10 and/or one or more displays of the mobile device(s) 20. The visual indicator 458 may be generated based on the determined ranking of the potential intermediate destinations. As mentioned, some additional or alternative embodiments of the visual indicator 458 may be configured as a graphical user interface displayed by one or more screens or touch screens included in the vehicle 10 and/or the display(s) of mobile device(s) 20 of the passenger(s). Such a graphical user interface may allow for communicating data to the vehicle 10, the system 100, and/or the navigation routing module 242. Such data communicated may indicate touch screen interactions, activated buttons, dials, nobs, and/or other suitable input interface elements included or associated with the vehicle 10 and/or the mobile device(s) 20. Thus, embodiments of the graphical user interface may allow for the passenger(s) to select one or more of the potential intermediate destinations as the intermediate destination(s). Additionally or alternatively, the method 348 may include and/or the passenger information module 240 or navigation routing module 242 may be configured to update passenger profiles 243 based on such interactions with the graphical user interface. Such interactions and/or updates may additionally or alternatively be utilized to train or retrain artificial intelligence algorithms included in the navigation routing module 242 and/or associated with the method 348.

Referring now to FIGS. 1-3, once the final destination and intermediate destination(s) have been determined by the system 100 and/or selected by the passenger(s), a guidance route including such destinations may be generated. For example and in at least one embodiment, the method 348 may include and/or the navigation routing module 242 may be configured to generate a guidance route including the intermediate destination(s) and the final destination(s), see method element 356. Thereafter, the generated guidance route may be communicated to the vehicle navigation system 28 and/or the vehicle navigation system 28 may provide vehicle routing and navigation based on the generated guidance route including the intermediate destination(s) and the final destination. In the case of an autonomous vehicle 10, an associated autonomous driving system may selectively or automatically operate the vehicle along the generated guidance route.

In some situations, an additional passenger may be picked up or enter the vehicle 10 after the guidance route is generated, at described herein. In response to the additional passenger, some embodiments of the method 348 may include and/or the passenger information module 240 may be configured to retrieve past travel information and/or future schedule information for the additional passenger of the vehicle 10, as described herein with respect to the original passengers. Furthermore and in response to retrieving the past travel information and/or the future schedule information for the additional passenger, some embodiments of the method 348 may include and/or the navigation routing module 242 may be configured to determine an updated final destination and/or an updated intermediate destination based the past travel information and/or the future schedule information for the additional passenger, as described herein with respect to the original passengers. Thereafter, the method 348 may include and/or the navigation routing module 242 may be configured to update the guidance route to include the updated intermediate destination and/or the updated final destination. The updated guidance route may similarly be provided to or utilized by the vehicle navigation system 28 and/or autonomous driving system, as described above.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

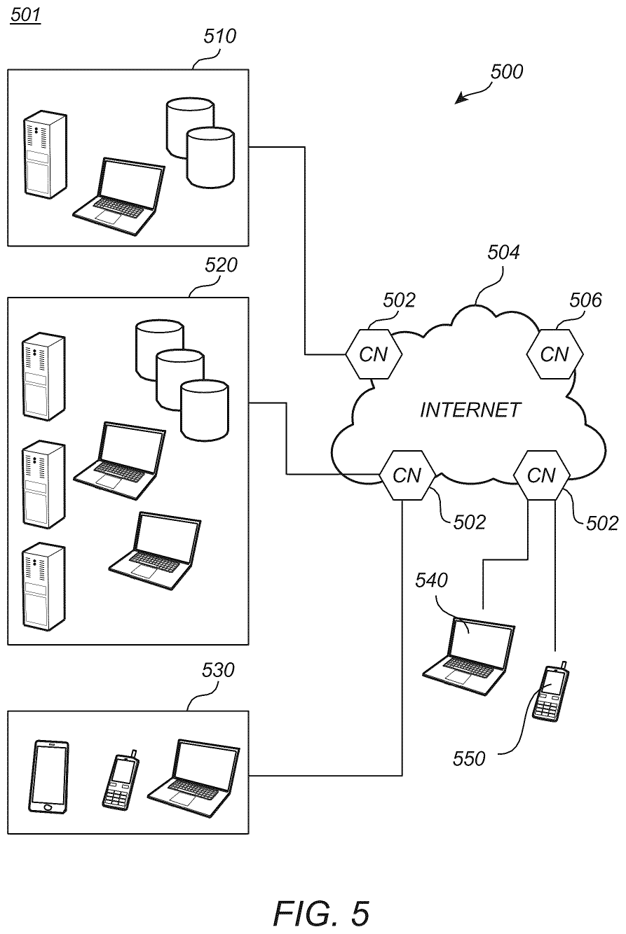

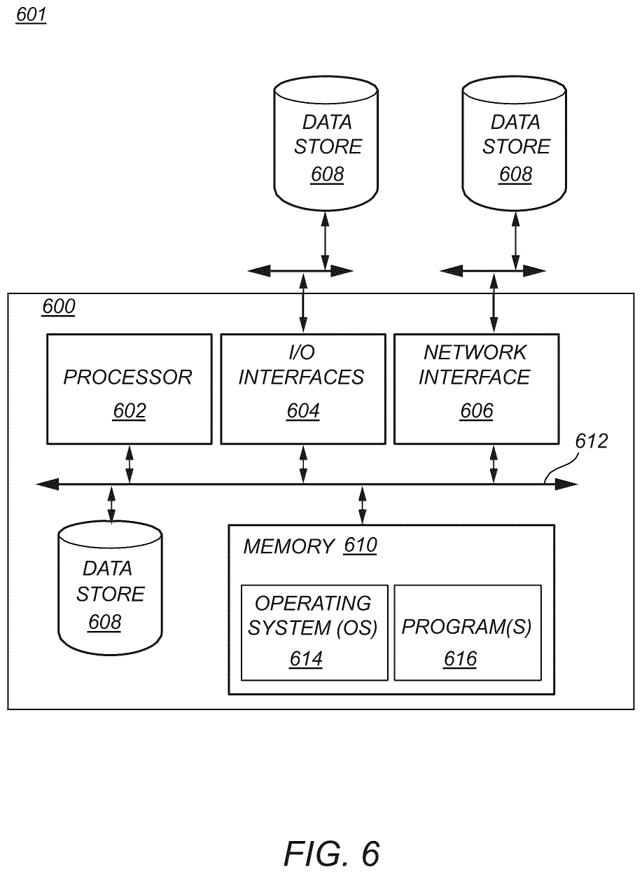

FIG. 5 is a network diagram of a cloud-based system 500 for implementing various cloud-based services of the present disclosure. The cloud-based system 500 includes one or more cloud nodes (CNs) 502 communicatively coupled to the Internet 504 or the like. The cloud nodes 502 may be implemented as a server 600 (as illustrated in FIG. 6) or the like and can be geographically diverse from one another, such as located at various data centers around the country or globe. Further, the cloud-based system 500 can include one or more central authority (CA) nodes 506, which similarly can be implemented as the server 600 and be connected to the CNs 502. For illustration purposes, the cloud-based system 500 can connect to a regional office 510, headquarters 520, various employee's homes 530, laptops/desktops 540, and mobile devices 550, each of which can be communicatively coupled to one of the CNs 502. These locations 510, 520, and 530, and devices 540 and 550 are shown for illustrative purposes, and those skilled in the art will recognize there are various access scenarios to the cloud-based system 500, all of which are contemplated herein. The devices 540 and 550 can be so-called road warriors, i.e., users off-site, on-the-road, etc. The cloud-based system 500 can be a private cloud, a public cloud, a combination of a private cloud and a public cloud (hybrid cloud), or the like.

Again, the cloud-based system 500 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 510, 520, and 530 and devices 540 and 550. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 500 is replacing the conventional deployment model. The cloud-based system 500 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 500 is illustrated herein as one example embodiment of a cloud-based system, and those of ordinary skill in the art will recognize the systems and methods described herein are not necessarily limited thereby.

FIG. 6 is a block diagram of a server 600, which may be used in the cloud-based system 500 (FIG. 5), in other systems, or stand-alone. For example, the CNs 502 (FIG. 5) and the central authority nodes 506 (FIG. 5) may be formed as one or more of the servers 600. The server 600 may be a digital computer that, in terms of hardware architecture, generally includes a processor 602, input/output (I/O) interfaces 604, a network interface 606, a data store 608, and memory 610. It should be appreciated by those of ordinary skill in the art that FIG. 6 depicts the server 600 in an oversimplified manner, and a practical embodiment may include additional components and suitably configured processing logic to support known or conventional operating features that are not described in detail herein. The components (602, 604, 606, 608, and 610) are communicatively coupled via a local interface 612. The local interface 612 may be, for example, but is not limited to, one or more buses or other wired or wireless connections, as is known in the art. The local interface 612 may have additional elements, which are omitted for simplicity, such as controllers, buffers (caches), drivers, repeaters, and receivers, among many others, to enable communications. Further, the local interface 612 may include address, control, and/or data connections to enable appropriate communications among the aforementioned components.

The processor 602 is a hardware device for executing software instructions. The processor 602 may be any custom made or commercially available processor, a central processing unit (CPU), an auxiliary processor among several processors associated with the server 600, a semiconductor-based microprocessor (in the form of a microchip or chipset), or generally any device for executing software instructions. When the server 600 is in operation, the processor 602 is configured to execute software stored within the memory 610, to communicate data to and from the memory 610, and to generally control operations of the server 600 pursuant to the software instructions. The I/O interfaces 604 may be used to receive user input from and/or for providing system output to one or more devices or components.

The network interface 606 may be used to enable the server 600 to communicate on a network, such as the Internet 504 (FIG. 5). The network interface 606 may include, for example, an Ethernet card or adapter (e.g., 10BaseT, Fast Ethernet, Gigabit Ethernet, or 10GbE) or a Wireless Local Area Network (WLAN) card or adapter (e.g., 802.11a/b/g/n/ac). The network interface 606 may include address, control, and/or data connections to enable appropriate communications on the network. A data store 608 may be used to store data. The data store 608 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media. In one example, the data store 608 may be located internal to the server 600, such as, for example, an internal hard drive connected to the local interface 612 in the server 600. Additionally, in another embodiment, the data store 608 may be located external to the server 600 such as, for example, an external hard drive connected to the I/O interfaces 604 (e.g., a SCSI or USB connection). In a further embodiment, the data store 608 may be connected to the server 600 through a network, such as, for example, a network-attached file server.

The memory 610 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 610 may incorporate electronic, magnetic, optical, and/or other types of storage media. Note that the memory 610 may have a distributed architecture, where various components are situated remotely from one another but can be accessed by the processor 602. The software in memory 610 may include one or more software programs, each of which includes an ordered listing of executable instructions for implementing logical functions. The software in the memory 610 includes a suitable operating system (O/S) 614 and one or more programs 616. The operating system 614 essentially controls the execution of other computer programs, such as the one or more programs 616, and provides scheduling, input-output control, file and data management, memory management, and communication control and related services. The one or more programs 616 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

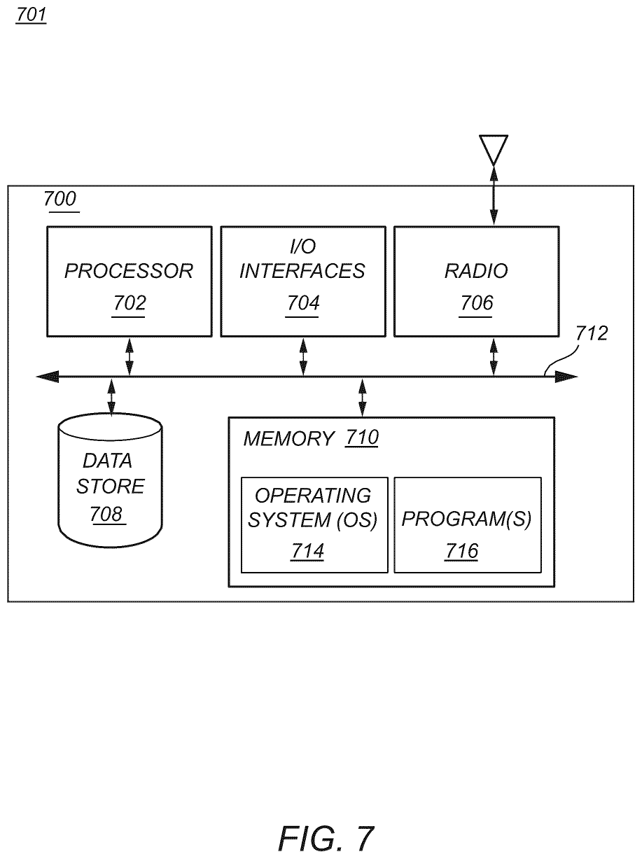

FIG. 7 is a block diagram of a user device 700, which may be used in the cloud-based system 500 (FIG. 5), as part of a network, or stand-alone. Again, the user device 700 can be a vehicle (e.g., one or more control units thereof), a smartphone, a tablet, a smartwatch, an Internet of Things (IoT) device, a laptop, a virtual reality (VR) headset, etc. The user device 700 can be a digital device that, in terms of hardware architecture, generally includes a processor 702, I/O interfaces 704, a radio 706, a data store 708, and memory 710. It should be appreciated by those of ordinary skill in the art that FIG. 7 depicts the user device 700 in an oversimplified manner, and a practical embodiment may include additional components and suitably configured processing logic to support known or conventional operating features that are not described in detail herein. The components (702, 704, 706, 708, and 710) are communicatively coupled via a local interface 712. The local interface 712 can be, for example, but is not limited to, one or more buses or other wired or wireless connections, as is known in the art. The local interface 712 can have additional elements, which are omitted for simplicity, such as controllers, buffers (caches), drivers, repeaters, and receivers, among many others, to enable communications. Further, the local interface 712 may include address, control, and/or data connections to enable appropriate communications among the aforementioned components.

The processor 702 is a hardware device for executing software instructions. The processor 702 can be any custom made or commercially available processor, a CPU, an auxiliary processor among several processors associated with the user device 700, a semiconductor-based microprocessor (in the form of a microchip or chipset), or generally any device for executing software instructions. When the user device 700 is in operation, the processor 702 is configured to execute software stored within the memory 710, to communicate data to and from the memory 710, and to generally control operations of the user device 700 pursuant to the software instructions. In an embodiment, the processor 702 may include a mobile optimized processor such as optimized for power consumption and mobile applications. The I/O interfaces 704 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 706 enables wireless communication to an external access device or network. Any number of suitable wireless data communication protocols, techniques, or methodologies can be supported by the radio 706, including any protocols for wireless communication. The data store 708 may be used to store data. The data store 708 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 708 may incorporate electronic, magnetic, optical, and/or other types of storage media.

Again, the memory 710 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 710 may incorporate electronic, magnetic, optical, and/or other types of storage media. Note that the memory 710 may have a distributed architecture, where various components are situated remotely from one another, but can be accessed by the processor 702. The software in memory 710 can include one or more software programs, each of which includes an ordered listing of executable instructions for implementing logical functions. In the example of FIG. 7, the software in the memory 710 includes a suitable operating system 714 and programs 716. The operating system 714 essentially controls the execution of other computer programs and provides scheduling, input-output control, file and data management, memory management, and communication control and related services. The programs 716 may include various applications, add-ons, etc. configured to provide end user functionality with the user device 700. For example, example programs 716 may include, but not limited to, a web browser, social networking applications, streaming media applications, games, mapping and location applications, electronic mail applications, financial applications, and the like. In a typical example, the end-user typically uses one or more of the programs 716 along with a network, such as the cloud-based system 500 (FIG. 5).

Again, embodiments of the disclosed systems and methods facilitate choosing destinations based on a navigation request from one more passengers of a vehicle and the qualities, past travel information, and/or schedule requirements of the passenger(s). A passenger information module and associated method elements may retrieve passenger information, such as passenger qualities, past travel information for the passenger(s), and/or future schedule information for the passenger(s). For example, such passenger information may be retrieved from one or more personal devices, mobile devices, cell phones, or the like of the passenger(s). In another example, the passenger(s) may be identified and associated with one or more passenger profiles, and some or all of the passenger information may be retrieved from the associated passenger profile(s). In some such embodiments, the passenger information module and associated method elements can identify the passenger(s) of the vehicle, the number of passengers, and/or assign passenger identifications (passenger IDs) based on passenger data indicating the passenger(s), such as vehicle sensor data and/or data retrieved from the personal device(s) of the passenger(s). Such determinations may be made utilizing appropriate artificial intelligence algorithms and/or by comparing qualities or features of the passenger(s) indicated by the passenger data and/or passenger profile(s).

A navigation routing module and associated method elements can receive the navigation request (e.g., a natural language statement, spoken command, or the like) from the passenger(s) of the vehicle and determine a final destination and one or more intermediate destinations based on the navigation request and the passenger information (e.g., the passenger qualities, the past travel information for the passenger(s), and/or the future schedule information for the passenger(s)). For example one or more suitable artificial intelligence algorithms or natural language processing algorithms may identify the final destination, the intermediate destination(s), types of such destinations (e.g., coffee places, breakfast restaurants, convenience stores, pharmacies, etc.), and/or one or more required arrival times based on the navigation request.

When a type of destination is indicated, multiple potential destinations may be determined. The future schedule information can be utilized to determine a required arrival time, or the communication request may indicate the required arrival time. The required arrival time may eliminate some of the potential destinations. The potential destinations may also be ranked in order to facilitate choosing the intermediate and/or final destination(s) from the potential destinations. For example, the past travel information for the passenger(s) may indicate favorite or often-visited potential destinations that are ranked higher than rarely visited or unvisited potential destinations. Further, destination information or qualities may be received and utilized to choose the intermediate and/or final destination(s) from the potential destinations. For example, a destination with a current or estimated destination duration allowing the passenger(s) to still arrive at the final destination by the required arrival time may be ranked higher. As another example, when the passenger qualities indicated by the passenger data or passenger profile(s) indicate a child passenger, casual potential destinations may be ranked higher than formal potential destinations.

Ultimately, the passenger(s) may select one or more of the highest-ranked potential destinations or the top-ranked potential destination(s) may be automatically selected, and a guidance route including the intermediate destination(s) and the final destination is generated. In some embodiments, when an additional passenger enters the vehicle, additional passenger information may be retrieved, and the final destination and/or intermediate destination(s) may be updated based on such additional passenger information. The guidance route may then be updated with the updated final destination and/or the updated intermediate destination(s).

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following, non-limiting Clauses and/or Claims for all purposes.

Clause 1: A vehicle comprising:
a system for providing vehicle navigation routing based on passenger habits, the system comprising a passenger information module and a navigation routing module.

Clause 2: A system for providing vehicle navigation routing based on passenger habits, the system comprising:
a passenger information module; and
a navigation routing module.

Clause 3: The system of any one of the previous clauses, wherein the passenger information module comprises instructions stored in at least one memory and executable by one or more processors to cause the passenger information module to retrieve passenger information for at least one passenger of the vehicle.

Clause 3: The system of any one of the previous clauses, wherein the navigation routing module comprises instructions stored in at least one memory and executable by one or more processors to cause the navigation routing module to receive a navigation request from the at least one passenger of the vehicle.

Clause 4: The system of any one of the previous clauses, wherein the navigation routing module comprises instructions stored in at least one memory and executable by one or more processors to cause the navigation routing module to determine a final destination and an intermediate destination based on the navigation request and the passenger information for the at least one passenger.

Clause 5: The system of any one of the previous clauses, wherein the navigation routing module comprises instructions stored in at least one memory and executable by one or more processors to cause the navigation routing module to generate a guidance route including the intermediate destination and the final destination.

Clause 6: The system of any one of the previous clauses, wherein passenger information for at least one passenger of the vehicle comprises passenger quality information for at least one passenger of the vehicle.

Clause 7: The system of any one of the previous clauses, wherein passenger information for at least one passenger of the vehicle comprises past travel information for at least one passenger of the vehicle.

Clause 8: The system of any one of the previous clauses, wherein passenger information for at least one passenger of the vehicle comprises future schedule information for at least one passenger of the vehicle.

Clause 9: The system of any one of the previous clauses, wherein the navigation routing module comprises instructions stored in at least one memory and executable by one or more processors to cause the navigation routing module to determine the final destination and the intermediate destination based on the navigation request and the passenger quality information for the at least one passenger.

Clause 10: The system of any one of the previous clauses, wherein the navigation routing module comprises instructions stored in at least one memory and executable by one or more processors to cause the navigation routing module to determine the final destination and the intermediate destination based on navigation request and the past travel information for the at least one passenger.

Clause 11: The system of any one of the previous clauses, wherein the navigation routing module comprises instructions stored in at least one memory and executable by one or more processors to cause the navigation routing module to determine the final destination and the intermediate destination based on navigation request and the future schedule information for the at least one passenger.

Clause 12: The system of any one of the previous clauses, wherein the passenger information module further comprises instructions stored in the at least one memory and executable by the one or more processors to cause the passenger information module to assign, based on data indicative of the at least one passenger of the vehicle, to each passenger of the at least one passenger a passenger identification (ID).

Clause 13: The system of any one of the previous clauses, wherein at least one of the past travel information or the future schedule information for the at least one passenger of the vehicle is retrieved from at least one passenger profile associated with the at least one passenger ID.

Clause 14: The system of any one of the previous clauses, wherein each passenger ID of the at least one passenger ID is assigned to each passenger of the at least one passenger utilizing an artificial intelligence algorithm.

Clause 15: The system of any one of the previous clauses, wherein at least one of the past travel information or the future schedule information for the at least one passenger is retrieved from at least one mobile device associated with the at least one passenger.

Clause 16: The system of any one of the previous clauses, wherein the navigation request comprises a natural language statement indicating at least one of the final destination or the intermediate destination.

Clause 17: The system of any one of the previous clauses, wherein the navigation routing module further comprises instructions stored in the at least one memory and executable by the one or more processors to cause the navigation routing module to interpret the natural language statement to identify the final destination and the intermediate destination utilizing an artificial intelligence algorithm.

Clause 18: The system of any one of the previous clauses, wherein the at least one passenger comprises a plurality of passengers.

Clause 19: The system of any one of the previous clauses, wherein at least one of the final destination and the intermediate destination are further determined based on at least one of the passenger quality information, the past travel information, or the future schedule information for multiple of the plurality of passengers.

Clause 20: The system of any one of the previous clauses, wherein at least one of the final destination and the intermediate destination are further determined based on at least one of the past travel information or the future schedule information for multiple of the plurality of passengers.

Clause 21: The system of any one of the previous clauses, wherein the passenger information module further comprises instructions stored in the at least one memory and executable by the one or more processors to cause the passenger information module to, in response to an additional passenger entering the vehicle subsequent to generating the guidance route, retrieve at least one of passenger quality information, past travel information, or future schedule information for the additional passenger of the vehicle.

Clause 22: The system of any one of the previous clauses, wherein the passenger information module further comprises instructions stored in the at least one memory and executable by the one or more processors to cause the passenger information module to, in response to an additional passenger entering the vehicle subsequent to generating the guidance route, retrieve at least one of past travel information or future schedule information for the additional passenger of the vehicle.

Clause 23: The system of any one of the previous clauses, wherein the navigation routing module further comprises instructions stored in the at least one memory and executable by the one or more processors to cause the passenger information module to, in response to retrieving at least one of the passenger quality information, the past travel information, or the future schedule information for the additional passenger of the vehicle, determine at least one of an updated final destination or an updated intermediate destination based on at least one of the passenger quality information, the past travel information, or the future schedule information for the additional passenger.

Clause 24: The system of any one of the previous clauses, wherein the navigation routing module further comprises instructions stored in the at least one memory and executable by the one or more processors to cause the passenger information module to, in response to retrieving at least one of the past travel information or the future schedule information for the additional passenger of the vehicle, determine at least one of an updated final destination or an updated intermediate destination based on at least one of the past travel information or the future schedule information for the additional passenger.

Clause 25: The system of any one of the previous clauses, wherein the navigation routing module further comprises instructions stored in the at least one memory and executable by the one or more processors to cause the passenger information module to update the guidance route to include at least one of the updated intermediate destination or the updated final destination.

Clause 26: The system of any one of the previous clauses, wherein the navigation request indicates at least one of a type of final destination or a type of intermediate destination.

Clause 27: The system of any one of the previous clauses, wherein determining the final destination and the intermediate destination is further based on at least one of the type of final destination or the type of intermediate destination.

Clause 28: The system of any one of the previous clauses, wherein the navigation routing module further comprises instructions stored in the at least one memory and executable by the one or more processors to cause the navigation routing module to determine geographic locations associated with the intermediate location and the final destination.

Clause 29: The system of any one of the previous clauses, wherein the navigation routing module further comprises instructions stored in the at least one memory and executable by the one or more processors to cause the navigation routing module to determine a plurality of potential intermediate destinations based on the navigation request and at least one of the past travel information or the future schedule information for the at least one passenger.

Clause 30: The system of any one of the previous clauses, wherein the intermediate destination is further determined by ranking the plurality of potential intermediate destinations based at least in part on the past travel information for the at least one passenger.

Clause 31: The system of any one of the previous clauses, wherein the navigation routing module further comprises instructions stored in the at least one memory and executable by the one or more processors to cause the navigation routing module to determine a plurality of potential intermediate destinations based on the navigation request and at least one of the passenger quality information, the past travel information, or the future schedule information for the at least one passenger.

Clause 32: The system of any one of the previous clauses, wherein the intermediate destination is further determined by ranking the plurality of potential intermediate destinations based at least in part on at least one of the passenger quality information, the past travel information, or the future schedule information for the at least one passenger.

Clause 33: The system of any one of the previous clauses, wherein the navigation routing module further comprises instructions stored in the at least one memory and executable by the one or more processors to cause the navigation routing module to determine a plurality of potential final destinations based on the navigation request and at least one of the past travel information or the future schedule information for the at least one passenger.

Clause 34: The system of any one of the previous clauses, wherein the final destination is further determined by ranking the plurality of potential final destinations based at least in part on the past travel information for the at least one passenger.

Clause 35: The system of any one of the previous clauses, wherein the navigation routing module further comprises instructions stored in the at least one memory and executable by the one or more processors to cause the navigation routing module to determine a plurality of potential final destinations based on the navigation request and at least one of the passenger quality information, the past travel information, or the future schedule information for the at least one passenger.

Clause 36: The system of any one of the previous clauses, wherein the final destination is further determined by ranking the plurality of potential final destinations based at least in part on at least one of the passenger quality information, the past travel information, or the future schedule information for the at least one passenger.

Clause 37: The system of any one of the previous clauses, wherein the navigation routing module further comprises instructions stored in the at least one memory and executable by the one or more processors to cause the navigation routing module to receive information indicative of at least one quality of at least one potential intermediate destination of the plurality of potential intermediate destinations.

Clause 38: The system of any one of the previous clauses, wherein the intermediate destination is further determined based on the at least one quality of the at least one potential intermediate destination.

Clause 39: The system of any one of the previous clauses, wherein the at least one of quality of the at least one potential intermediate destination comprises at least one of a current availability of at least one potential intermediate destination, a current estimate of a destination duration for at least one potential intermediate destination, an availability for a reservation for at least one potential intermediate destination, or a current or estimated wait time for at least one potential intermediate destination.

Clause 40: The system of any one of the previous clauses, wherein the navigation routing module further comprises instructions stored in the at least one memory and executable by the one or more processors to cause the navigation routing module to receive information indicative of at least one quality of at least one potential final destination of the plurality of potential final destinations.

Clause 41: The system of any one of the previous clauses, wherein the final destination is further determined based on the at least one quality of the at least one potential final destination.

Clause 42: The system of any one of the previous clauses, wherein the at least one of quality of the at least one potential final destination comprises at least one of a current availability of at least one potential final destination, an availability for a reservation for at least one potential final destination, or a current or estimated wait time for at least one potential final destination.

Clause 43: The system of any one of the previous clauses, wherein at least one of the navigation request, the past travel information for the at least one passenger, or the future schedule information for the at least one passenger indicates a required arrival time at the final destination, and

Clause 44: The system of any one of the previous clauses, wherein the intermediate destination is further determined based on the required arrival time at the final destination.

Clause 45: The system of any one of the previous clauses, further comprising a non-transitory computer-readable medium comprising instructions stored in at least one memory that, when executed by one or more processors, cause the one or more processors to carry out steps.

Clause 46: A method for providing vehicle navigation routing based on passenger habits utilizing the system of any of the previous clauses.

Clause 47: A non-transitory computer-readable medium comprising instructions stored in at least one memory that, when executed by one or more processors, cause the one or more processors to carry out steps.

Clause 48: The non-transitory computer-readable medium of any one of the previous clauses, wherein the steps comprise retrieving passenger information for at least one passenger of a vehicle.

Clause 49: The non-transitory computer-readable medium of any one of the previous clauses, wherein the steps comprise retrieving at least one of past travel information or future schedule information for at least one passenger of a vehicle.

Clause 50: The non-transitory computer-readable medium of any one of the previous clauses, wherein the steps comprise retrieving passenger quality information for at least one passenger of a vehicle.

Clause 51: The non-transitory computer-readable medium of any one of the previous clauses, wherein the steps comprise receiving a navigation request from the at least one passenger of the vehicle.

Clause 52: The non-transitory computer-readable medium of any one of the previous clauses, wherein the steps comprise determining a final destination and an intermediate destination based on the navigation request and the passenger information for the at least one passenger.

Clause 53: The non-transitory computer-readable medium of any one of the previous clauses, wherein the steps comprise determining a final destination and an intermediate destination based on the navigation request and at least one of the past travel information or the future schedule information for the at least one passenger.

Clause 54: The non-transitory computer-readable medium of any one of the previous clauses, wherein the steps comprise determining a final destination and an intermediate destination based on the navigation request and passenger quality information for the at least one passenger.

Clause 55: The non-transitory computer-readable medium of any one of the previous clauses, wherein the steps comprise generating a guidance route including the intermediate destination and the final destination.

Clause 56: The non-transitory computer-readable medium of any one of the previous clauses, wherein the steps comprise assigning, based on data indicative of the at least one passenger of the vehicle, to each passenger of the at least one passenger a passenger identification (ID).

Clause 57: The non-transitory computer-readable medium of any one of the previous clauses, wherein the passenger information for the at least one passenger of the vehicle is retrieved from at least one passenger profile associated with the at least one passenger ID.

Clause 58: The non-transitory computer-readable medium of any one of the previous clauses, wherein at least one of the past travel information or the future schedule information for the at least one passenger of the vehicle is retrieved from at least one passenger profile associated with the at least one passenger ID.

Clause 59: The non-transitory computer-readable medium of any one of the previous clauses, wherein the passenger quality information for the at least one passenger of the vehicle is retrieved from at least one passenger profile associated with the at least one passenger ID.

Clause 60: The non-transitory computer-readable medium of any one of the previous clauses, wherein the navigation request comprises a natural language statement indicating at least one of the final destination or the intermediate destination.

Clause 61: The non-transitory computer-readable medium of any one of the previous clauses, wherein the steps comprise interpreting the natural language statement to identify the final destination and the intermediate destination utilizing an artificial intelligence algorithm.

Clause 62: The non-transitory computer-readable medium of any one of the previous clauses, wherein the steps comprise retrieving, in response to an additional passenger entering the vehicle subsequent to generating the guidance route, at least one of past travel information or future schedule information for the additional passenger of the vehicle.

Clause 63: The non-transitory computer-readable medium of any one of the previous clauses, wherein the steps comprise retrieving, in response to an additional passenger entering the vehicle subsequent to generating the guidance route, passenger information for the additional passenger of the vehicle.

Clause 64: The non-transitory computer-readable medium of any one of the previous clauses, wherein the steps comprise retrieving, in response to an additional passenger entering the vehicle subsequent to generating the guidance route, passenger quality information for the additional passenger of the vehicle.

Clause 65: The non-transitory computer-readable medium of any one of the previous clauses, wherein the steps comprise determining, in response to retrieving the passenger information for the additional passenger of the vehicle, at least one of an updated final destination or an updated intermediate destination based on the passenger information for the additional passenger.

Clause 66: The non-transitory computer-readable medium of any one of the previous clauses, wherein the steps comprise determining, in response to retrieving at least one of the past travel information and the future schedule information for the additional passenger of the vehicle, at least one of an updated final destination or an updated intermediate destination based on at least one of the past travel information or the future schedule information for the additional passenger.

Clause 67: The non-transitory computer-readable medium of any one of the previous clauses, wherein the steps comprise determining, in response to retrieving passenger quality information for the additional passenger of the vehicle, at least one of an updated final destination or an updated intermediate destination based on the passenger quality information for the additional passenger.

Clause 68: The non-transitory computer-readable medium of any one of the previous clauses, wherein the steps comprise updating the guidance route to include at least one of the updated intermediate destination or the updated final destination.

Clause 69: The non-transitory computer-readable medium of any one of the previous clauses, wherein the navigation request indicates at least one of a type of final destination or a type of intermediate destination.

Clause 70: The non-transitory computer-readable medium of any one of the previous clauses, wherein determining the final destination and the intermediate destination is further based on at least one of the type of final destination or the type of intermediate destination.

Clause 71: The non-transitory computer-readable medium of any one of the previous clauses, wherein the steps comprise determining a plurality of potential intermediate destinations based on the navigation request and the passenger information for the at least one passenger.

Clause 72: The non-transitory computer-readable medium of any one of the previous clauses, wherein the steps comprise determining a plurality of potential intermediate destinations based on the navigation request and at least one of the past travel information or the future schedule information for the at least one passenger.

Clause 73: The non-transitory computer-readable medium of any one of the previous clauses, wherein the steps comprise determining a plurality of potential intermediate destinations based on the navigation request and the passenger quality information for the at least one passenger.

Clause 74: The non-transitory computer-readable medium of any one of the previous clauses, wherein the steps comprise determining a plurality of potential final destinations based on the navigation request and the passenger information for the at least one passenger.

Clause 75: The non-transitory computer-readable medium of any one of the previous clauses, wherein the steps comprise determining a plurality of potential final destinations based on the navigation request and at least one of the past travel information or the future schedule information for the at least one passenger.

Clause 76: The non-transitory computer-readable medium of any one of the previous clauses, wherein the steps comprise determining a plurality of potential final destinations based on the navigation request and the passenger quality information for the at least one passenger.

Clause 77: The non-transitory computer-readable medium of any one of the previous clauses, wherein the intermediate destination is further determined by ranking the plurality of potential intermediate destinations based at least in part on the passenger information for the at least one passenger.

Clause 78: The non-transitory computer-readable medium of any one of the previous clauses, wherein the intermediate destination is further determined by ranking the plurality of potential intermediate destinations based at least in part on the past travel information for the at least one passenger.

Clause 79: The non-transitory computer-readable medium of any one of the previous clauses, wherein the intermediate destination is further determined by ranking the plurality of potential intermediate destinations based at least in part on the future schedule information for the at least one passenger.

Clause 80: The non-transitory computer-readable medium of any one of the previous clauses, wherein the intermediate destination is further determined by ranking the plurality of potential intermediate destinations based at least in part on the passenger quality information for the at least one passenger.

Clause 81: The non-transitory computer-readable medium of any one of the previous clauses, wherein the final destination is further determined by ranking the plurality of potential final destinations based at least in part on the passenger information for the at least one passenger.

Clause 82: The non-transitory computer-readable medium of any one of the previous clauses, wherein the final destination is further determined by ranking the plurality of potential final destinations based at least in part on the past travel information for the at least one passenger.

Clause 83: The non-transitory computer-readable medium of any one of the previous clauses, wherein the final destination is further determined by ranking the plurality of potential final destinations based at least in part on the future schedule information for the at least one passenger.

Clause 84: The non-transitory computer-readable medium of any one of the previous clauses, wherein the final destination is further determined by ranking the plurality of potential final destinations based at least in part on the passenger quality information for the at least one passenger.

Clause 85: The non-transitory computer-readable medium of any one of the previous clauses, wherein at least one of the navigation request, the past travel information for the at least one passenger, or the future schedule information for the at least one passenger indicates a required arrival time at the final destination.

Clause 86: The non-transitory computer-readable medium of any one of the previous clauses, wherein the intermediate destination is further determined based on the required arrival time at the final destination.

What is claimed is:

1. A system for providing vehicle navigation routing based on passenger habits, the system comprising:
a passenger information module comprising instructions stored in at least one memory and executable by one or more processors to cause the passenger information module to:
retrieve at least one of past travel information or future schedule information for at least one passenger of the vehicle;
a navigation routing module comprising instructions stored in at least one memory and executable by one or more processors to cause the navigation routing module to:
receive a navigation request from the at least one passenger of the vehicle;
determine a final destination and an intermediate destination based on the navigation request and at least one of the past travel information or the future schedule information for the at least one passenger; and
generate a guidance route including the intermediate destination and the final destination.

2. The system of claim 1, wherein the passenger information module further comprises instructions stored in the at least one memory and executable by the one or more processors to cause the passenger information module to:
assign, based on data indicative of the at least one passenger of the vehicle, to each passenger of the at least one passenger a passenger identification (ID),
wherein at least one of the past travel information or the future schedule information for the at least one passenger of the vehicle is retrieved from at least one passenger profile associated with the at least one passenger ID.

3. The system of claim 2, wherein each passenger ID of the at least one passenger ID is assigned to each passenger of the at least one passenger utilizing an artificial intelligence algorithm.

4. The system of claim 1, wherein at least one of the past travel information or the future schedule information for the at least one passenger is retrieved from at least one mobile device associated with the at least one passenger.

5. The system of claim 1, wherein the navigation request comprises a natural language statement indicating at least one of the final destination or the intermediate destination, and wherein the navigation routing module further comprises instructions stored in the at least one memory and executable by the one or more processors to cause the navigation routing module to:
interpret the natural language statement to identify the final destination and the intermediate destination utilizing an artificial intelligence algorithm.

6. The system of claim 1, wherein the at least one passenger comprises a plurality of passengers, and wherein at least one of the final destination and the intermediate destination are further determined based on at least one of the past travel information or the future schedule information for multiple of the plurality of passengers.

7. The system of claim 1, wherein:
the passenger information module further comprises instructions stored in the at least one memory and executable by the one or more processors to cause the passenger information module to, in response to an additional passenger entering the vehicle subsequent to generating the guidance route:
retrieve at least one of past travel information or future schedule information for the additional passenger of the vehicle; and
wherein the navigation routing module further comprises instructions stored in the at least one memory and executable by the one or more processors to cause the passenger information module to, in response to retrieving at least one of the past travel information and the future schedule information for the additional passenger of the vehicle:
determine at least one of an updated final destination or an updated intermediate destination based on at least one of the past travel information or the future schedule information for the additional passenger; and
update the guidance route to include at least one of the updated intermediate destination or the updated final destination.

8. The system of claim 1, wherein the navigation request indicates at least one of a type of final destination or a type of intermediate destination, and wherein determining the final destination and the intermediate destination is further based on at least one of the type of final destination or the type of intermediate destination.

9. The system of claim 1, wherein the navigation routing module further comprises instructions stored in the at least one memory and executable by the one or more processors to cause the navigation routing module to:
determine geographic locations associated with the intermediate location and the final destination.

10. The system of claim 1, wherein the navigation routing module further comprises instructions stored in the at least one memory and executable by the one or more processors to cause the navigation routing module to:
determine a plurality of potential intermediate destinations based on the navigation request and at least one of the past travel information or the future schedule information for the at least one passenger, and
wherein the intermediate destination is further determined by ranking the plurality of potential intermediate destinations based at least in part on the past travel information for the at least one passenger.

11. The system of claim 1, wherein the navigation routing module further comprises instructions stored in the at least one memory and executable by the one or more processors to cause the navigation routing module to:
receive information indicative of at least one quality of at least one potential intermediate destination of the plurality of potential intermediate destinations, and
wherein the intermediate destination is further determined based on the at least one quality of the at least one potential intermediate destination.

12. The system of claim 11, wherein the at least one of quality of the at least one potential intermediate destination comprises at least one of a current availability of at least one potential intermediate destination, a current estimate of a destination duration for at least one potential intermediate destination, an availability for a reservation for at least one potential intermediate destination, or a current or estimated wait time for at least one potential intermediate destination.

13. The system of claim 1, wherein at least one of the navigation request, the past travel information for the at least one passenger, or the future schedule information for the at least one passenger indicates a required arrival time at the final destination, and wherein the intermediate destination is further determined based on the required arrival time at the final destination.

14. A non-transitory computer-readable medium comprising instructions stored in at least one memory that, when executed by one or more processors, cause the one or more processors to carry out steps comprising:
retrieving at least one of past travel information or future schedule information for at least one passenger of a vehicle;
receiving a navigation request from the at least one passenger of the vehicle;
determining a final destination and an intermediate destination based on the navigation request and at least one of the past travel information or the future schedule information for the at least one passenger; and
generating a guidance route including the intermediate destination and the final destination.

15. The non-transitory computer-readable medium of claim 14, wherein the steps further comprise:
assigning, based on data indicative of the at least one passenger of the vehicle, to each passenger of the at least one passenger a passenger identification (ID),
wherein at least one of the past travel information or the future schedule information for the at least one passenger of the vehicle is retrieved from at least one passenger profile associated with the at least one passenger ID.

16. The non-transitory computer-readable medium of claim 14, wherein the navigation request comprises a natural language statement indicating at least one of the final destination or the intermediate destination, and wherein the steps further comprise:
interpreting the natural language statement to identify the final destination and the intermediate destination utilizing an artificial intelligence algorithm.

17. The non-transitory computer-readable medium of claim 14, wherein the steps further comprise:
retrieving, in response to an additional passenger entering the vehicle subsequent to generating the guidance route, at least one of past travel information or future schedule information for the additional passenger of the vehicle;
determining, in response to retrieving at least one of the past travel information and the future schedule information for the additional passenger of the vehicle, at least one of an updated final destination or an updated intermediate destination based on at least one of the past travel information or the future schedule information for the additional passenger; and
updating the guidance route to include at least one of the updated intermediate destination or the updated final destination.

18. The non-transitory computer-readable medium of claim 14, wherein the navigation request indicates at least one of a type of final destination or a type of intermediate destination, and wherein determining the final destination and the intermediate destination is further based on at least one of the type of final destination or the type of intermediate destination.

19. The non-transitory computer-readable medium of claim 14, wherein the steps further comprise:
determining a plurality of potential intermediate destinations based on the navigation request and at least one of the past travel information or the future schedule information for the at least one passenger, and
wherein the intermediate destination is further determined by ranking the plurality of potential intermediate destinations based at least in part on the past travel information for the at least one passenger.

20. The non-transitory computer-readable medium of claim 14, wherein at least one of the navigation request, the past travel information for the at least one passenger, or the future schedule information for the at least one passenger indicates a required arrival time at the final destination, and wherein the intermediate destination is further determined based on the required arrival time at the final destination.
